(19) United States
(12) Patent Application Publication
(10) Pub. No.: US 2024/0036153 A1
(43) Pub. Date: Feb. 1, 2024

(54) Systems and Methods for RF Emitter Location with Automatic UAS Array Reconfiguration

(71) Applicants: Mitchell Aaron THORNTON, Dallas, TX (US); Eric Cooper LARSON, Garland, TX (US); Mark Anthony BIGHAM, Heath, TX (US)

(72) Inventors: Mitchell Aaron THORNTON, Dallas, TX (US); Eric Cooper LARSON, Garland, TX (US); Mark Anthony BIGHAM, Heath, TX (US)

(21) Appl. No.: 18/226,663

(22) Filed: Jul. 26, 2023

Related U.S. Application Data
(60) Provisional application No. 63/369,911, filed on Jul. 29, 2022.

(51) Int. Cl. G01S 5/02; H04W 64/00; G01S 5/14

(52) U.S. Cl. CPC G01S 5/0284; H04W 64/006; G01S 5/145

(57) ABSTRACT

Systems and Methods for RF Emitter Location with automatic UAS array reconfiguration. The system includes at least a first emitter of electromagnet emissions. There is an array controller and, in some situations, at least one array follower. The controller(s) each have a receiver to receive signals from the first emitter. The controller calculates the location of the first emitter based upon communications with the first emitter and any array follower.

### PRIORITY

The present invention claims priority to U.S. Provisional Application No. 63/369,911 filed Jul. 29, 2022, the entirety of which is hereby incorporated by reference.

### BACKGROUND OF THE INVENTION

### Technical Field

The present invention relates to a system and method for RF Emitter Location with automatic UAS array reconfiguration.

### Description of Related Art

Prior art methods for emitter location are based upon fixed array geometries within a system such as the fixed location of an antenna array mounted on an aircraft fuselage or at fixed terrestrial locations. This provides significant disadvantages. Consequently, there is a need for improving the placement and accuracy of emitter location.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts an example emitter location scenario wherein the dynamic array elements are embodied within separate and distinct UAS in one embodiment;

FIG. 2 depicts an example emitter location scenario wherein the dynamic array element locations are updated to enable refinement of current emitter location estimates and to allow additional emitter location estimates to be obtained by enhancing objectives based on the FOV in one embodiment;

FIG. 3 depicts a block diagram of the major components of a dynamic array element embodied as a UAS in one embodiment;

FIG. 4 depicts the geometry of the scenarios in FIGS. 1 and 2 in a co-planar two-dimensional axis system in one embodiment;

FIG. 5 depicts an alternative view of FIG. 4 wherein the coplanar two-dimensional coordinate system is shown with x- and y-axes;

FIG. 6 depicts a single UAS approach in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

Prior art methods for array-based emitter location are based upon fixed array geometries within a system such as the fixed location of an antenna array mounted on an aircraft fuselage or at fixed terrestrial locations. For mobile systems, such as a fixed array mounted on an aircraft fuselage, those skilled in the art are aware that there is a degree of freedom with respect to relocating the sensor array during an emitter location mission, but that the relative locations of the array elements are fixed. While emitter location accuracy can be improved through the repositioning of the sensor array, the fixed relative positions of the sensor comprising the system results in limitations. These limitations can degrade the emitter location accuracy and can limit the operable field-of-view (FOV) of the system. For example, an array of sensors in fixed locations on an aircraft fuselage can severely limit the FOV with regard to the elevation angle of the host aircraft and a ground-based emitter while also imposing lesser but significant location accuracies in the azimuthal plane.

This disclosure, in some embodiments, concerns a system comprising one or more unmanned autonomous devices with mobility to provide estimates of the location of a radio frequency (RF) transmitter. Examples include unmanned aerial system (UAS) platforms, unmanned terrestrial-based systems (UTS) that are autonomously mobile, space-based or satellite systems (SBS), combinations of UAS, UTS or SBS platforms operable as a coordinated system, or the augmentation of any of these systems with fixed-location components. While a UAS platform is described below, this is for illustrative purposes only and should not be deemed limiting. Each system component comprises an RF receiver and antenna that is coupled to an onboard computing system, a means for communications among the system components as well as optionally to an external entity, and a local onboard navigation system for each component. Within each system component, the antenna/receiver serves as the RF sensor, the internal navigation unit provides the position of each component, the onboard computing system hosts the emitter location algorithms, and the communications means enables each component to exchange information among other system components and an external entity.

Geolocation of RF emitters external to the said system has applications in areas such as search and rescue, payload delivery, military applications, and others. In these applications, it is useful to provide an accurate estimate of the geolocation of an RF emitter whose actual location is unknown but for which one of more of the system components is capable of detecting the presence of the RF emissions from the external source. For example, a search and rescue mission might require the ability to obtain the geolocation estimate of an emergency transponder beacon.

There are several prior art methods for estimating the geolocation of RF emitters. These include approaches based upon received power density of the emitter, interferometry, TDOA, beamforming, cyclostationary signal processing, and hybrid approaches. Emitter location methods are known to generally provide enhanced emitter location accuracies in proportion to the number of sensors within an array. Emitter location accuracy is further known to depend upon several characteristics of the system including the relative spatial geometry and positioning of the array elements and the RF emitter of interest.

The disclosed system and method solves the problem of reduced emitter location accuracy due to fixed array geometry limitations by replacing each sensor within the fixed array with an independently mobile platform such as UAS or UTS. Furthermore, the system of UAS/UTS components comprises the ability to automatically adapt and reconfigure their relative locations with respect to one another offering the capability to dynamically change the array geometry. Through the capability of dynamic array reconfiguration, subsequent emitter location estimates can occur wherein the array geometry is automatically adapted to enhance subsequent emitter location estimates. The capability to dynamically change the array geometry through repositioning of the array, wherein the array comprises one or more of the said systems, results in increasing the operational FOV and enables accurate emitter location estimates to be acquired with fewer measurement observations.

Additionally, a related method solves the problem of reducing RF emitter location error with a single platform by utilizing signal power density and the precise 3D features of the building or structure the RF emitter is located in or in close proximity to. We refer to this method as Feature Aided Signal Tracking (FAST).

The increased operational FOV provided by this disclosure enables emitter location estimates to be obtained for relative array and emitter geometries that would otherwise be limited due to incompatible overall geometries. In particular three-dimensional geolocation estimates can be obtained since the dynamic array can be oriented in the vertical plane coincident with the emitter and not restricted to a small range of elevation angles. Additionally, limitations due to the antenna pattern peaks and nulls present on each dynamic array element can be overcome by causing each dynamic array element to physically rotate; effectively enabling antenna pattern peaks and nulls to be oriented in any desired direction with respect to the external emitter location.

Since the orientation of the array element with respect to the location of the emitter can be dynamically changed, increased emitter location accuracies can be achieved with fewer samples of the received emissions. Adaptively reconfiguring the array upon subsequent measurements enables an optimal (or estimated optimal) orientation of the array with respect to the position of the emitter. Thus, subsequent measurements increase in accuracy. This is particularly important if the emitter only transmits RF signals in relatively short time periods.

Finally, the use of the dynamic array can enable the geolocation of emitters that may be located in positions for which fixed array methods are infeasible. For example, an emitter that is located beneath a tree canopy or within a large building or subterranean mine can be geolocated with a dynamic array comprised of UAS whereas a fixed array mounted on an aircraft fuselage would be obstructed.

A method may be implemented and present on the onboard computer readable media of the one or more said systems that allows for improving the accuracy of the emitter locations, determining new positions of the one or more said systems, and to classify, predict, compute, or extract secondary information of interest.

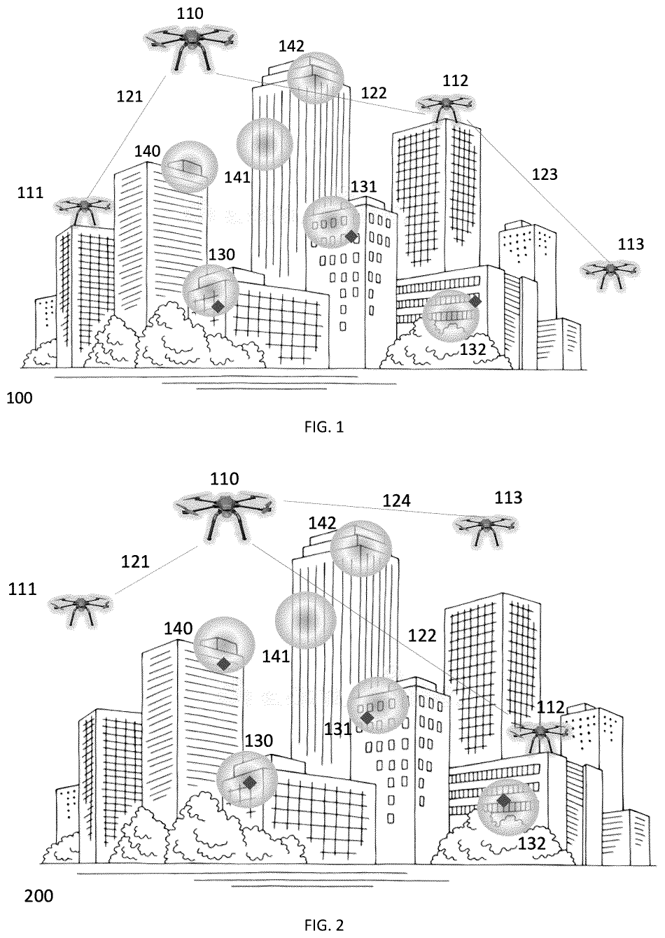

Turning to the figures, FIG. 1 illustrates an emitter location scenario 100 wherein the dynamic array elements are embodied as four equipped and positioned UAS 110-113. A wireless communication network is established and comprises communication channels 121-123. UAS 110 is designated as the array controller element that communicates with UAS 111-113. In this scenario, UAS 110 communicates with UAS 113 through a combined channel formed by 122 and 123 herein UAS 112 serves as a communications relay. The ability to optionally choose any UAS comprising the dynamic array to serve as a relay for communications to the array controller UAS 110 enables power conservation and enhances wireless network signal-to-noise ratio (SNR) since difficulties due to non-line of sight, blockage, or multipath conditions can exist for a given array geometry. In one embodiment, the array controller 110 communicates and directs at least one array follower (UAS 111-113, as depicted) to move to a new position.

The ability to dynamically change the designation of relayed communication links is advantageous and it is generally the case that the overall number of relayed channels should be minimized to balance overall network bandwidth requirements; however, the use of channel relays is important to overcome issues due blockage and multipath or to reduce the power consumption of UAS onboard transmitters. Furthermore, the array also has the ability to dynamically choose or elect a new UAS to serve as the array controller. Thus, the array follower (UAS 111-113, as depicted), can become the new array controller 110, and the previous array controller 110, becomes an array follower. Enabling the designation of the array controller to dynamically change offers advantages that include optimizing the required intra-network SNR, minimizing required intra-network power usage, and minimizing the number of relay UASs.

Within the FIG. 1 scenario 100, six emitters are present as indicated by heat maps representing their actual transmitted power densities 130-132 and 140-142. The emitters, in one embodiment, comprise a first emitter, a second emitter, a third emitter, a fourth emitter, a fifth emitter, and a sixth emitter. The true emitter location is at the center of each heat map 130-132 and 140-142 with the estimated emitter location due to an emitter location method denoted by the small diamond-shaped symbols within the heat maps 130-132. The emitter location estimate error is thus the distance from the diamond-shaped symbol to the center of each respective heat map. Emitters 130-132 have been observed and emitter location estimates have been computed by the dynamic array. Emitters 140-142 represent emitters whose location have not been estimated. Dynamic array elements embodied within UAS 111 and 112 are shown as resting on the top of buildings to conserve onboard power and to reduce the emitter location estimate errors due to hover drift, onboard navigation system errors, and other effects such as wind gusts.

FIG. 2 illustrates an updated dynamic array geometry that allows for the emitter location estimates for emitters 130-132 to be updated resulting in increased accuracy and also to allow for a geolocation estimate of emitter 140 to be computed. The updated locations for the UAS 110-113 where computed by array controller 110 and transmitted to UAS 111-113 via the use of the wireless communications channels. In this exemplary case, it was determined that the locations of UAS 111-113 should change and the location of UAS 110 should remain the same as in scenario 100. It should be noted that the location of UAS could similarly have changed. Additional characteristics of this updated array positioning include the fact that the relayed communications channel 123 in scenario 100 was replaced with a direct channel 124 that exists between UAS 110 and UAS 113. Furthermore, it was determined that UAS 110 would continue to serve as the array controller, although any of the UAS 110-113 could have been elected to serve this purpose in scenario 200.

Scenario 200 indicates that the emitter location estimates for emitters 130-132 increased in accuracy since the diamond-shaped symbols representing the location estimates are closer to the center of the power density heat maps. Additionally, a new emitter location estimate is computed for emitter 140 and is shown in scenario 200 as the diamond-shaped symbol in the power density heat map of 140.

The computation of the updated array geometry 200 as compared to the original array geometry 100 consisted in part of the array controller 110 receiving information from UAS 111-113. This information includes data regarding the emitter location measurements of each UAS, information concerning the network power usage, and optionally, information regarding potential new emitters in the environment that were not yet geolocated during the scenario 100 measurements. After array controller UAS 110 receives this data from the other UAS, it computes new positions for each array element, including itself, and transmits this information to each UAS in the array. After receiving the new positioning data, the UAS move to their updated positions in scenario 200. Next, the wireless network automatically reconfigures to maximize network overall SNR and to determine if relayed channels should be established. To further optimize the network re-configuration, current array controller 110 determines if another member of the array should serve as the array controller. If it is determined that a new array controller should be chosen, this designation is broadcast to each UAS in the array and the newly chosen array controller assumes the coordinating responsibilities for future dynamic array changes.

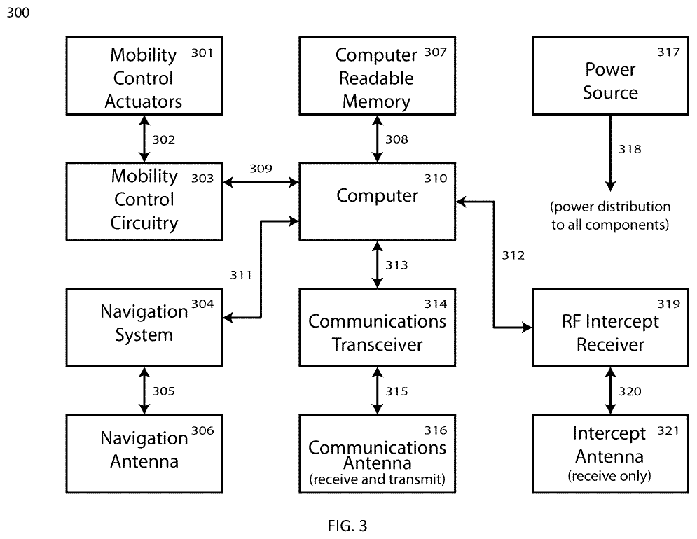

FIG. 3 contains a block diagram 300 of components comprising a dynamic array element embodied as a UAS. Each UAS comprises a general set of components to support the functionality of a typical UAS, as is well known to those skilled in the art, with additional components included to support the RF emitter geolocation application. In some cases, typical UAS components are modified to support the geolocation application. For example power source 317 and corresponding power distribution network 318 are enhanced to provide power to the additional components in 300 that are included to support the RF emitter location task. It is noted that block diagram 300 illustrates only those UAS components that are required to support the role of serving as a dynamic array element in a RF emitter location application such as that depicted in FIG. 1 and FIG. 2. Artisans of UAS technology will be aware of additional components present in typical UAS platforms such as mechanical propulsion elements and other interfaces.

UAS mobility control circuitry 303 is coupled to actuators 301 as indicated by line 302. UAS mobility components are well-known to exist in generic UAS platforms and are responsible for enabling the UAS to reposition its physical location.

The navigation system 304 represents any of a plurality of choices. For example, 304 can represent a global positioning system (GPS) receiver coupled to a GPS antenna module 306 via line 305. Block diagram elements 304-306 may likewise comprise a specialized interface to receive navigation information from an external entity. In some embodiments, the navigation system 304 may not require a navigation antenna 306 or coupling line 305; such as the case where the navigation unit 306 is in the form of an initialized inertial navigation system (INS) using onboard gyroscopes. The navigation system comprising blocks 304-306 may represent one or more of the previously mentioned options including the use of customized navigation systems such as those that operate in a GPS-denied environment. In one embodiment the system includes an external source such as one which transmits global coordinate system information to said system. The global coordinate system, such as those provided by a GPS system, can be transmitted to an array controller, array follower, etc. In one embodiment the system converts local coordinates such as described herein to global coordinates. This allows the system to utilize local coordinates when helpful, but convert to global coordinates when necessary. Further, there are situations wherein the GPS provided global coordinates, or global coordinates from some other external system, are not available. The system would then utilize local coordinates. The provided said global coordinates can be for the array, or they can be for another location such as a corner of a building. The array can then move to the corner of the building to correlate its local coordinates with those received by the external system providing global coordinates. The system would then be able to convert global coordinates to local coordinates and vice versa. Thus, in one embodiment, the system needs only one global coordinate which it can match with a local coordinate. Once the system can convert global coordinates to local coordinates and vice versa, the system can convert coordinates for all components of the system including the array controller, array follower, emitters, etc.

Elements 314-316 comprise the UAS infrastructure to enable it to communicate with external entities such as other UAS comprising the dynamic array including the elected array controller UAS. Additional external communications are supported by elements 314-316 and may include communications with a ground station or human operator. The communications protocols supported by elements 314-316 may be standardized wireless protocols including one or more of the WiFi (IEEE 802.11) family, cellular telephone standards including 5G, BlueTooth, or other standards as would be known by one skilled in the art. Furthermore, non-standard communications protocols may be used to support communications elements 314-316.

In one embodiment, each UAS is equipped with an RF intercept receiver 319 and antenna 321 that are coupled via line 320. Although intercept receiver 319 is depicted as a separate component with respect to communications transceiver 314, in some embodiments the communications functions of 316 and the intercept functions of 319 may be shared. In some embodiments, intercept receiver 319 may be in the form of a software-defined radio (SDR). Advantages in using an SDR to fulfill the role of block 319 include flexibility with respect to tuning ranges, demodulation capabilities, received signal bandwidth selection, and others as are known to those skilled in the art. The function of components 319-321 are to detect the presence of RF emissions in the ambient electromagnetic (EM) environment to support the geolocation capability of the dynamic array. Electromagnetic emissions comprise any emissions which contain electromagnetic energy and can include communications, data, etc. Optional features of intercept receiver 319 include the capability to demodulate received EM emissions, to estimate the received emission SNR, and to perform other analyses of the received emissions. These optional features may be controlled through manual, automatic, or combination of manual/automatic means. Automatic detection of signal modulation type and received signal SNR can be accomplished as described in [HL+:20][HS+:21]. Alternatively, the intercept functions of receiver 319 may be in the form of a conventional fixed tunable or non-tunable receiver as would be apparent to those skilled in the art.

Antennas 306, 316 and 321 may be present as separate and distinct antennas, or alternatively one or more of these antennas can be shared with appropriate feed networks (not shown in 300) that comprise filtering, RF distribution, and other components as are known to those skilled in the art. Antennas 306, 316, and 321 may further comprise a single or a plurality of elements. For example, if a beamforming approach is implemented for RF emitter location, intercept antenna 321 will comprise a fixed array of elements onboard the UAS. Likewise, if an amplitude-based geolocation method is implemented, one or more elements comprising the intercept antenna 321 may be supported by a mechanical means to physically rotate 321 at some known RPM (revolutions per minute) angular velocity to enable the intercept antenna pattern to rotate. Likewise, the RF feed network that interfaces the intercept antenna element 321 with the intercept receiver 319 (not shown in FIG. 3) may comprise controllable variable phase=shifting circuitry that allow the antenna patterns to be modified electronically via control signals issued from either computer 310 or receiver 319. In the case of a beamforming method, such phase-shifting control signals are issued to the RF feed network in an event-driven manner whereas an amplitude-based method would utilize phase-shifting control signals that cause the antenna pattern of 321 to periodically and electronically rotate at some pre-determined angular velocity. If the amplitude-based method is implemented, another option would be to implement antenna 321 as a fixed element or array of elements, and to rotate the antenna pattern physically be causing the mobility subsystem to rotate the entire UAS.

The on-board computing system comprises elements 307-310. In addition to hosting computations to support typical and well-known functionality in support of a UAS, such as interfacing to the mobility control circuitry when the UAS is moving or stationary, additional functionality is present in the system to support the geolocation mission. Any of a variety of emitter location methods are implemented as instructions present in the computer readable memory (CRM) 307. Well-known emitter location methods include amplitude-based, phase interferometric, beamforming, TDOA, beamforming, cyclostationary signal processing, and hybrid approaches. Computer 310 may optionally comprise specialized processing hardware to enhance the emitter location calculations including either commercial off-the-shelf (COTS) components or custom-designed hardware. One example of a COTS hardware component is the inclusion of a graphical processing unit (GPU) that is well-known to increase the performance of certain mathematical computations. An example of a customized component is the inclusion of a high-speed and low-jitter clock signal generation circuit that could be used to time stamp intercepted signal artifacts when a TDOA emitter location method is employed. Those skilled in the art will appreciate and understand the engineering tradeoffs that exist when designing the architecture of the UAS in its supporting role as a dynamic array element for a RF emitter location application. For example, if a cyclostationary emitter location algorithm is implemented, the inclusion of a specialized COTS or custom-designed circuit for computing the covariance matrix and its corresponding eigenvalues of an intercepted signal by an array of elements comprising block 321 would enable enhanced speed in performing emitter location; however, the overall power requirements and weight of the UAS would likewise increase. Alternatively, implementing the covariance matrix formulation and associated eigenvalue computations supporting a cyclostationary emitter location as instructions present in the CRM 307 would enable the UAS to have reduced weight and power requirements while also increasing the delay of processing each observation of an external RF emitter.

CRM 307 is used to store instructions retrieved and executed by computer 310 to enable the UAS to perform a number of tasks. These tasks include support for the generic operation of the UAS such as internal commands to other components and interacting with the mobility control circuitry. In support of the dynamic array geolocation mission, the CRM will contain instructions that implement one or more emitter location methods; either wholly or in part if additional supporting hardware is included as described previously. Additionally, CRM 307 will comprise instructions that enable the UAS to function as an array controller if it is elected to serve in that role. CRM 307 will also contain instructions that implement the functionality to interact with intercept receiver 319 including prioritizing the list of tuning frequencies and other settings such as bandwidth.

Optionally, the CRM may contain instructions to automatically predict received RF signal modulation type and SNR level using methods such as those described in [HL+:20][HS+:21] or others.

Optionally, CRM 307 may contain instructions that enable the determination of specific instances in the intercepted signal wherein time stamps should be applied to generate TOA values. The generation of TOA time stamps is important when the dynamic array for RF emitter location is implementing a method such as the TDOA method. Emitter location accuracy with respect to TDOA methods requires that TOA values be assigned to the same and similar samples of an intercepted RF emission to ensure that calculated TDOA values are as accurate as possible. The spatial separation due to different physical locations of the UAS serving as sensors causes the TOA of an intercepted signal instance to vary due to the finite speed of propagation of EM energy. Therefore, knowledge of the propagation speed, the distances between pairs of UAS, the location of pairs of UAS, and the TOA of intercepted signal samples among pairs of UAS allow the emitter location estimate to be computed. Errors in any of the above values due to noise, clock resolution, or inaccurate TOA time stamps affect the overall emitter location accuracy.

A variety of means can be used to increase the TOA accuracy. One of these means is to use a very high-speed clock generator to reduce error due to resolution limits that also has very low drift and jitter rates to decrease the bias and random error associated with the clock. Clock signal generation and its effects on TDOA-based emitter location accuracy is discussed in more detail in the following paragraphs. Another means is to increase the emitter location estimation accuracy is to account for small differences in UAS location due to hover drift. Yet another means to increase the emitter location estimation accuracy is to ensure that intercepted RF signals have time stamped TOAs applied to the same sample point of the signal as received by different UAS platforms. This latter error source can be minimized in a plurality of ways. One way is to enable each UAS to have knowledge of the signal structure of the received signal. For example, if the intercepted signal is of a form wherein a specific artifact is present, such as the presence of a synchronization or “start” bit in a wireless packet-based data communications signal, each UAS can simply search for the presence of the synchronization bit and provide time stamps to that portion of the signal. This approach requires that the UAS have a priori knowledge, or perhaps automatically recognized knowledge, pertaining to the structure and type of signal that is being received by 319. Another possible means of enhancing the accuracy of time stamping the received signal is to enable a pair of UAS to exchange a sequence of stored samples of a recently received signal. In this manner, each UAS may execute a time-series cross-correlation technique implemented as stored instructions in CRM 307. By maximizing the cross-correlation coefficients, the associated time lag would yield the TDOA directly. Yet another method is to enhance the correlation method or the recognition of signal artifacts with a machine learning (ML) approach such as a neural network or LSTM recurrent network to further enhance the accuracy of choosing stored signal samples representing the same instant in an intercepted signal as received by multiple UAS array elements.

Navigation system 304 may further be augmented with special purpose circuitry as needed to support the RF emitter location mission. As an example, if a TDOA based method is implemented for geolocation, block 304 can supply time stamping information in a periodic or on-demand fashion that is used by computer 310 to determine TOA and TDOA of intercepted RF emission artifacts. Some navigation systems, such as GPS, inherently provide accurate time information. Furthermore, the use of COTS or customized clock signal generators can be incorporated in a variety of different elements within block diagram 300 such as within the computer 310, intercept receiver 321, the communications transceiver 316, or even as a separate standalone element that is interfaced to any of these components.

The dynamic array system that is the subject of FIGS. 1-3 embodies a TDOA-based RF emitter location method referred to as the “location on the conic axis” (LOCA) [Sch:72]. The LOCA method is operable when three or more physically separated dynamic array elements and the emitter to be located are coplanar. When the three or dynamic array elements and the emitter deviate from co-planarity, a bias error in the location estimate occurs that is proportional to the degree non-planarity. TDOA values are measured among pairs of dynamic array elements and are used to analytically compute a conic section wherein the conic section intersects the locations of the array elements and the emitter location estimate is at the position of one of the conic section foci. Some conic sections have a single focal point, such as a parabola or circle. Other conic sections have two foci such as an ellipse or hyperbola. Conic sections include the well-known planar shapes of circle, ellipse, parabola and hyperbola. A convenient metric common to all conic sections is termed the eccentricity, E. The value of the eccentricity indicates which of the conic shapes are present. A circle has an eccentricity of zero (E=0), an ellipse has an eccentricity of 0<E<1, a parabola has an eccentricity of E=1, and a hyperbola has an eccentricity of E>1. A circle is likewise characterized by its radius which is one-half of the diameter. The focal point of a circle is the point contained within the circle that is equidistant to all points lying on the circle and is thus the center point of the circle. An ellipse is further characterized by two lines referred to as the semi-minor and semi-major axes. The two focal points of an ellipse lie along the semi-major axis. Circles and parabolas comprise a single focal point whereas ellipses and hyperbolas comprise two focal points. The LOCA method is operable when the conic section in the plane containing three dynamic array elements and the emitter have a relative geometry wherein the three array elements lie on conic section boundary, the emitter of interest is located at one of the focal points, and the conic section is either a circle or an ellipse. One method for determining if a proper geometry is present for emitter location using the LOCA method is to compute the eccentricity and to ensure that it has a value in the range 0≤E<1. When the eccentricity falls within this range, the coplanar conic section is either a circle or an ellipse. For the case of an ellipse, where two foci are present, 0<E<1, one focal point represents the actual emitter location and the other represents an ambiguous point in space that must be resolved. Arrays comprising four or more array elements enable ambiguity resolution by computing multiple ellipses with groups of three array elements and choosing the common focal point, assuming that appropriate eccentricity values represent the coplanar geometries [DS:13].

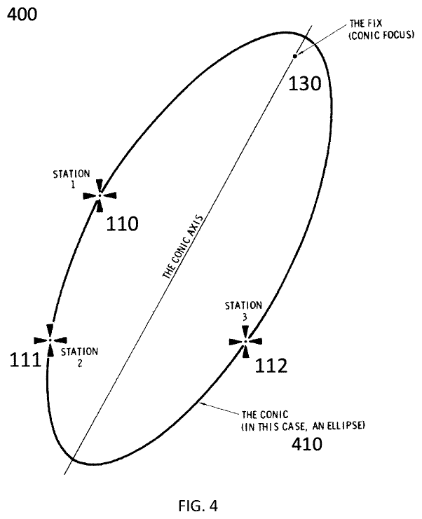

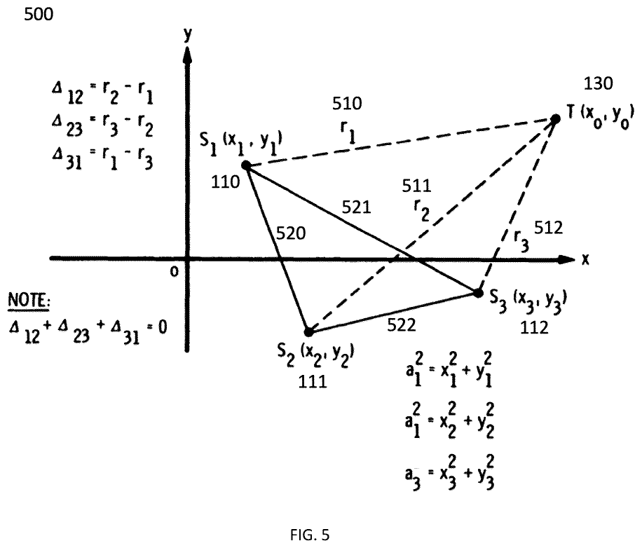

In FIGS. 1 and 2, illustrations 100 and 200 depict a dynamic array of four networked UASs that serve as dynamic array elements for the purpose of estimating the geolocation of RF emitters using the LOCA method. The dynamic array comprises multiple sensor apertures due to their respective onboard antennas 321. The intercept receivers 319 embodied within UAS 110-113 are not phase coherent. Therefore, the emitter location method is limited to an amplitude-based or TDOA-based approaches such as the LOCA method [Sch:72]. The geometry of the scenarios in FIGS. 1 and 2 are reproduced in a co-planar two-dimensional axis system as shown in FIG. 4. FIG. 4 also contains the conic section, an ellipse, that intersects the positions of UAS 110-113 with the focal point in the upper rightmost portion of FIG. 4 representing the emitter location.

FIG. 5 depicts an alternative view of FIG. 4 wherein the coplanar two-dimensional coordinate system is shown with x- and y-axes. The location of the origin in FIG. 5 is arbitrary and may be placed at any convenient point within the plane. The points labeled S₁, S₂ and S₃ represent the locations of UASs 110, 111 and 112 respectively. The coordinates of the UASs are likewise labeled as (x₁, y₁), (x₂, y₂) and (x₃, y₃) for UASs 110, 111 and 112 respectively. The length of line segments 510, 520 and 521 represent the distances between pairs of dynamic array elements. The length of line segment 520 represents the distance between UAS 110 and 111, the length of line segment 521 represents the distance between UAS 110 and 112, and the length of line segment 522 represents the distance between UAS 111 and 112. Assuming that UAS 110 is serving as the elected array controller UAS, it receives location data from the navigation systems 304 of UAS 111 and 112 via the wireless communications channels supported by the 314/316 components of UAS 111 and 112. Using these received locations of 111 and 112 in conjunction with 110's own location obtained from its onboard navigation component 304, these points are also converted into coplanar relative locations (x₁, y₁), (x₂, y₂) and (x₃, y₃) that correspond to the positions of the three UAS 110-112. Using these received locations of 111 and 112 in conjunction with 110's own location obtained from its onboard navigation component 304, the three ranges 520, 521 and 522 are computed using computer 310 onboard UAS 110. The array controller furthermore computes the two-dimensional plane containing the points of the conic section that intersects the planar positions (x₁, y₁), (x₂, y₂) and (x₃, y₃) that correspond to the locations of UASs 110-112 respectively. Given the points (x₁, y₁), (x₂, y₂) and (x₃, y₃), the eccentricity E of the conic section intersecting them can be computed. If the eccentricity indicates the conic section is a circle or ellipse, 0≤E<1, an emitter location estimate is computed using the LOCA method. If the eccentricity E does not indicate a circle or ellipse for the conic section, the array controller predicts a new geometry and the dynamic array comprised of UASs 110-112 are repositioned. Furthermore, each UAS must be located at different ranges to the target. Therefore, three conditions that govern dynamic array re-positioning when using the LOCA based method with three or more sensors are:
1) A minimum of three UAS and the emitter must be coplanar
2) Among the entire complement of coplanar UAS s, at least three UAS must have locations such that their respective ranges to the emitter are different
3) The eccentricity of the conic section fall within the interval 0≤E<1 to ensure that either a circle or ellipse is the form of the conic section

When the above three conditions are satisfied, the LOCA emitter location calculation can proceed and is described here with additional details given in [Sch:72]. It is assumed that the ranges from the emitter to the UASs are sufficiently small such that curvature of the earth is negligible, thus all calculations are Euclidean and occur with the assumption that the range values fall along a straight line. Furthermore, it is assumed that the ranges from the UASs to the emitter are long enough that they fall within the far-field of the EM transmissions of the emitter. Far-field propagation is typically considered to be a distance in excess of 20 wavelengths in terms of the emitter's carrier frequency although values other than 20 may be assumed in some cases. Far-field assumptions enable the emissions to be approximated as having planar wavefronts. Furthermore, the effects of in-band signal interference are not considered as it is further assumed that the intercept receivers 319 have sufficiently narrow bandwidths as to reject any transmissions from other emitters that are closely spaced to the emitter of interest in terms of carrier frequency. The wavefront of the transmissions from the emitter of interest is assumed to have a constant propagation speed equal to the speed of light in a vacuum, c. Alternative values for EM phase velocity, c, can be used without loss of generality so long as it is a constant. Distances, or range values r, are easily computed by dividing the EM propagation speed c by a propagation delay value (in units of time).

FIG. 5 shows the ranges from the emitter 130 to each of the UASs 110, 111, and 112 as dashed line segments 510, 511 and 512 labeled as r₁, r₂ and r₃ respectively. The array controller 110 receives the relative locations (x₂, y₂) and (x₃, y₃) that correspond to the positions of the three UAS 111-112 via the dynamic array wireless intra-network supported by the navigation systems 304-306 and the wireless network communications interface 314-316 onboard UAS 111 and 112. The array controller is also aware of its own position (x₁, y₁) due to its own internal navigation system 304-306. The array controller 110 also receives the TOA time stamps TOA for a given emitter reception via the wireless communication system supporting the intra-network of the dynamic array. Furthermore, the array controller 110 has its own TOA measurement for the same received time sample. Thus, the array controller 110 uses the three TOA values and the three locations of the UASs 110-112 to perform the LOCA emitter location estimate.

FIG. 5 denotes the three UASs 110-112 as “Stations” 1, 2 and 3 respectively. The local coordinates, described herein, provide a local coordinate system which can be used in lieu of global coordinates. Local coordinates provide coordinates or location information based on a local area with respect to some arbitrary coordinate system origin—as opposed to traditional global coordinates, such as latitude, longitude and height above sea level that may be unavailable to the emitter location system. In some embodiments global coordinates are unavailable, and accordingly, local coordinates are used. As noted, the system can convert global coordinates to local coordinates and vice versa. The local coordinates can be in an (x, y) format or an (x, y, z) format or any other format as would be known to one skilled in the art.

In keeping with the notation of [Sch:72] UASs 110-112 are mathematically denoted as S₁(x₁, y₁), S₂(x₂, y₂) and S₃(x₃, y₃) respectively and the emitter to be located is denoted as T(x₀, y₀). Thus, the localized planar coordinates of each station Sᵢ are likewise given as (x₁, y₁), (x₂, y₂) and (x₃, y₃) with respect to stations S₁, S₂ and S₃. Likewise, the localized planar coordinates of the emitter to be located is (x₀, y₀). The inter-station ranges are shown as solid line segments 520, 521 and 522 and are denoted as Δ₁₂, Δ₁₃ and Δ₂₃ where the subscript ij in the variable Δᵢⱼ is the range between UAS Sᵢ and UAS Δⱼ in units of distance. Array controller 110 calculates the Δᵢⱼ values as the Euclidean distance among the three (x₁, y₁), (x₂, y₂) and (x₃, y₃) values. The range of each UAS to the arbitrarily chosen origin of the two-dimensional plane where the UASs and the emitter are coplanar is denoted as aᵢ for UAS i. The array controller computes aᵢ², the square of the distance of UAS i to the origin as aᵢ²=xᵢ²+yᵢ². From results in analytic geometry, the linear equation for the conic axis in the two-dimensional plane can be computed using the quantities (x₁, y₁), (x₂, y₂) and (x₃, y₃) x₁, y₁, x₂, y₂, x₃, y₃, Δ₁₂, Δ₃₁, Δ₂₃, a₁², a₂² and a₃² as given in Equation (1).

(x₁Δ₂₃+x₂Δ₃₁+x₃Δ₁₂)x+(y₁Δ₂₃+y₂Δ₃₁+y₃Δ₁₂)x=½(Δ₁₂Δ₂₃Δ₃₁+a₁²Δ₂₃+a₂²Δ₃₁+a₃²Δ₁₂) (1)

Since Equation (1) is a line coincident with the conic axis, the emitter location (x₀, y₀) is a point on the line.

TDOA values. For the sake of notation, we will let TOAᵢ represent the measured TOA for UAS i. Likewise, TDOAᵢⱼ represents the time difference of arrival of an instance of an emitted transmission among UASs i and j.

(x₂, y₂) and (x₃, y₃) that correspond to the positions of the three UAS 110-112 the three TDOA values into ranges among the three UASs 110-112 by dividing the propagation speed, typically the speed of light, by each TDOA resulting in the range values it receives TOA measurements from UAS 111 and 112, and computes the three TDOA values as the positive arithmetic difference of pairs of TOA the LOCA method is shown below, from Schmidt [1], where the “Stations” represent known locations of sensors, and the “The Fix” is the location of the target.

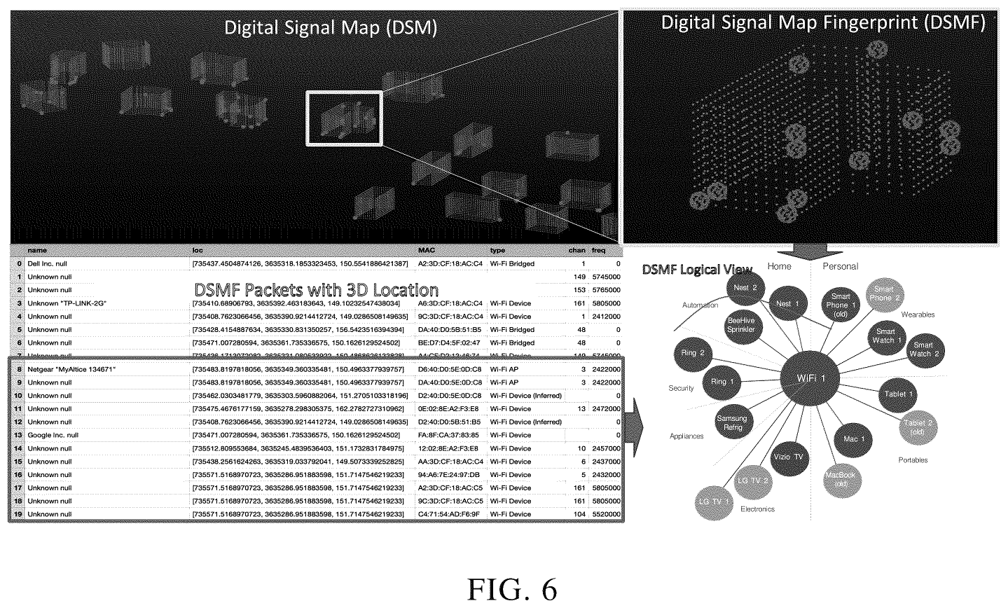

FIG. 6 depicts a single UAS approach in one embodiment. While one embodiment has been described with a plurality of UAS, this is for illustrative purposes only and should not be deemed limiting. In other embodiments only a single UAS is utilized. In such an embodiment, the UAS can move to generate update location predictions.

While the invention has been particularly shown and described with reference to a preferred embodiment, it will be understood by those skilled in the art that various changes in form and detail may be made therein without departing from the spirit and scope of the invention. Furthermore, it should be noted that the above-mentioned embodiments illustrate rather than limit the invention, and that those skilled in the art will be able to design many alternative embodiments without departing from the scope of the appended claims. In the claims, the word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

What is claimed is:

1. A system for determining location of an emitter, said system comprising:
a first emitter of electromagnetic emissions;
an array controller and at least one array follower;
wherein said array controller and said at least one array follower each comprises a receiver to receive signals from said first emitter;
a controller coupled to said array controller to communicate with said at least one array follower and said array controller;
wherein said controller calculates a location of said first emitter based upon communications with said at least one array follower and said array controller.

2. The system of claim 1 wherein said array controller and said at least one array follower each comprises an unmanned aerial system (UAS).

3. The system of claim 1 wherein said array controller communicates with and directs said at least one array follower to move to a new position.

4. The system of claim 1 wherein said at least one array follower becomes said array controller and wherein said array controller becomes an array follower.

5. The system of claim 1 comprising a second emitter.

6. The system of claim 1 wherein said array controller comprises a computer, and an antenna, wherein said receiver comprises an RF intercept receiver, and an antenna.

7. The system of claim 5 wherein said array controller further comprises mobility control actuators.

8. The system of claim 1 further comprising an external source which transmits global coordinate system information to said array controller.

9. The system of claim 1 further comprising an external source which transmits global coordinate system information to said array follower.

10. The system of claim 9 wherein said system converts local coordinates to global coordinates.

11. The system of claim 10 wherein a computer coupled to said array controller converts local coordinates to global coordinates.

12. The system of claim 1 wherein said array controller is stationary.

13. The system of claim 1 wherein said location of said first emitter is converted from local coordinates to global coordinates.

14. A method for determining location of an emitter, said method comprising the steps of:
a) receiving a first signal from a first emitter;
b) calculating a first estimated emitter location;
c) receiving a second signal from a first emitter;
c) calculating a second estimated emitter location based on said second signal.

15. The method of claim 14 further comprising one array controller and at least one array follower.

16. The method of claim 1452 further comprising the step of determining if the location of said at least one array follower should change.

17. The method of claim 15 further comprising the step of determining if the array controller should change.

18. The method of claim 15 wherein said array controller moves relative to said first emitter prior to receiving said second signal.

19. The method of claim 15 wherein said array controller and said at least one array follower each comprises an unmanned aerial system (UAS).

20. The method of claim 14 wherein said receiving of step a) comprises receiving by a controller, and wherein said method further comprises moving said controller relative to said first emitter prior to obtaining said second signal.

21. The method of claim 14 further comprising the step of obtaining global coordinate systems using an external source.

22. The method of claim 21 wherein said global coordinate systems can be converted to local coordinates.

23. A system for determining location of an emitter, said system comprising:
a first emitter of electronic emissions;
an array controller;
wherein said array controller comprises a receiver to receive signals from said first emitter;
wherein said array controller can move independently relative to said first emitter;
wherein said controller calculates a location of said first emitter based upon electronic emissions from said first emitter.

24. The system of claim 23 wherein said array controller is located on a vehicle.
